(19) United States
(12) Patent Application Publication
(10) Pub. No.: US 2013/0184024 A1
(43) Pub. Date: Jul. 18, 2013

(54) Asymmetric D2D Communication

(71) Applicants: Tao CHEN, Espoo (FI); Kari RIKKINEN, Il (FI)

(72) Inventors: Tao CHEN, Espoo (FI); Kari RIKKINEN, Il (FI)

(73) Assignee: Renesas Mobile Corporation

(21) Appl. No.: 13/357,758

(22) Filed: Jan. 25, 2012

(30) Foreign Application Priority Data
Jan. 18, 2012 (GB) 1200816.5

(51) Int. Cl. H04W 72/04

(52) U.S. Cl. 455/509

(57) ABSTRACT

There is provided a method for an asymmetric device-to-device, D2D, communication, the method including from the first terminal point of view: acquiring, by the first user terminal incapable to receive uplink data, information indicating whether or not to apply an asymmetric D2D communication with a second user terminal capable to receive uplink data; and upon applying the asymmetric D2D communication with the second user terminal, performing at least one of the following: acquiring data from the second user terminal via a base station of the cellular network, and causing transmission of data directly to the second user terminal.

### FIELD

The invention relates generally to mobile communication networks. More particularly, the invention relates to device-to-device communications within cellular network.

### BACKGROUND

User equipment (UE) may communicate with another UE conventionally via base station(s), for example. Alternatively, it is proposed that the UEs may communicate directly by applying network resources dedicated by a cellular network for a device-to-device (D2D) communication. The D2D communication has proven to be network efficient by offloading the traffic processed in the base station(s), for example.

However, there may be situations when there are both D2D capable devices and legacy devices in a cell of the cellular network. This may cause problems in configuring an efficient communication scheme within the cell.

### BRIEF DESCRIPTION OF THE INVENTION

Embodiments of the invention seek to improve the D2D communication taking place in and utilizing the resources of a cellular network.

According to an aspect of the invention, there is provided a method as specified in claim 1.

According to an aspect of the invention, there are provided apparatuses as specified in claims 7 and 13.

According to an aspect of the invention, there is provided a method, comprising: acquiring, by a second user terminal capable to receive uplink data, information indicating whether or not to apply an asymmetric D2D communication with a first user terminal incapable to receive uplink data; and upon applying the asymmetric D2D communication with the first user terminal, performing at least one of the following: acquiring data directly from the first user terminal, and causing transmission of data to the first user terminal via a base station of the cellular network.

According to an aspect of the invention, there is provided an apparatus comprising: at least one processor and at least one memory including a computer program code, wherein the at least one memory and the computer program code are configured to, with the at least one processor, cause the apparatus at least to: acquire information indicating whether or not a second user terminal capable to receive uplink data is to apply an asymmetric D2D communication with a first user terminal incapable to receive uplink data; and upon applying the asymmetric D2D communication with the first user terminal, perform at least one of the following: acquire data directly from the first user terminal, and cause transmission of data to the first user terminal via a base station of the cellular network.

According to an aspect of the invention, there is provided a method comprising: acquiring, by a base station of the cellular network, information of D2D communication capabilities of a first user terminal and a second user terminal; selecting, at least partly based on the acquired D2D communication capabilities, which communication scheme is to be applied by the first user terminal and the second user terminal among a plurality of communication schemes, wherein the selected communication scheme utilizes at least one of the following: a conventional cellular communication between the first and second user terminals, a symmetrical D2D communication wherein each of the first and second user terminal transmits data directly to the other user terminal, an asymmetric D2D communication wherein only the first user terminal transmits data directly to the second user terminal by applying the uplink resources of the cellular network; causing transmission of indication about which communication scheme to apply to the first user terminal and the second user terminal; and upon application of the communication scheme utilizing the asymmetric D2D communication, causing forwarding of data from the second user terminal to the first user terminal.

According to an aspect of the invention, there is provided a computer program product embodied on a distribution medium readable by a computer and comprising program instructions which, when loaded into an apparatus, execute the method according to any of the appended claims.

According to an aspect of the invention, there is provided an apparatus comprising means configured to cause the apparatus to perform any of the embodiments as described in the appended claims.

According to an aspect of the invention, there is provided an apparatus comprising processing means for performing any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a communication network according to an embodiment;

FIGS. 2 and 3 show methods for performing an asymmetric D2D communication according to some embodiments;

FIG. 4 illustrates the asymmetric D2D communication according to an embodiment;

FIG. 5 presents a method performed by an eNB according to an embodiment;

FIG. 6 depicts a signaling flow diagram according to an embodiment; and

FIGS. 7 and 8 illustrate apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Radio communication networks, such as the Long Term Evolution (LTE) or the LTE-Advanced (LTE-A) of the 3^{rd} Generation Partnership Project (3GPP), are typically composed of at least one base station (also called a base transceiver station, a radio network controller, a Node B, or an evolved Node B, for example), at least one user equipment (UE) (also called a user terminal, terminal device or a mobile station, for example) and optional network elements that provide the interconnection towards the core network. The base station may be node B (NB) as in the LTE, evolved node B (eNB) as in the LTE-A, a radio network controller (RNC) as in the UMTS, a base station controller (BSC) as in the GSM/GERAN, or any other apparatus capable of controlling radio communication and managing radio resources within a cell. The base station may connect the UEs via the so-called radio interface to the network. In general, a base station may be configured to provide communication services according to at least one of the following radio access technologies (RATs): Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), LTE, and/or LTE-A. The present embodiments are not, however, limited to these protocols.

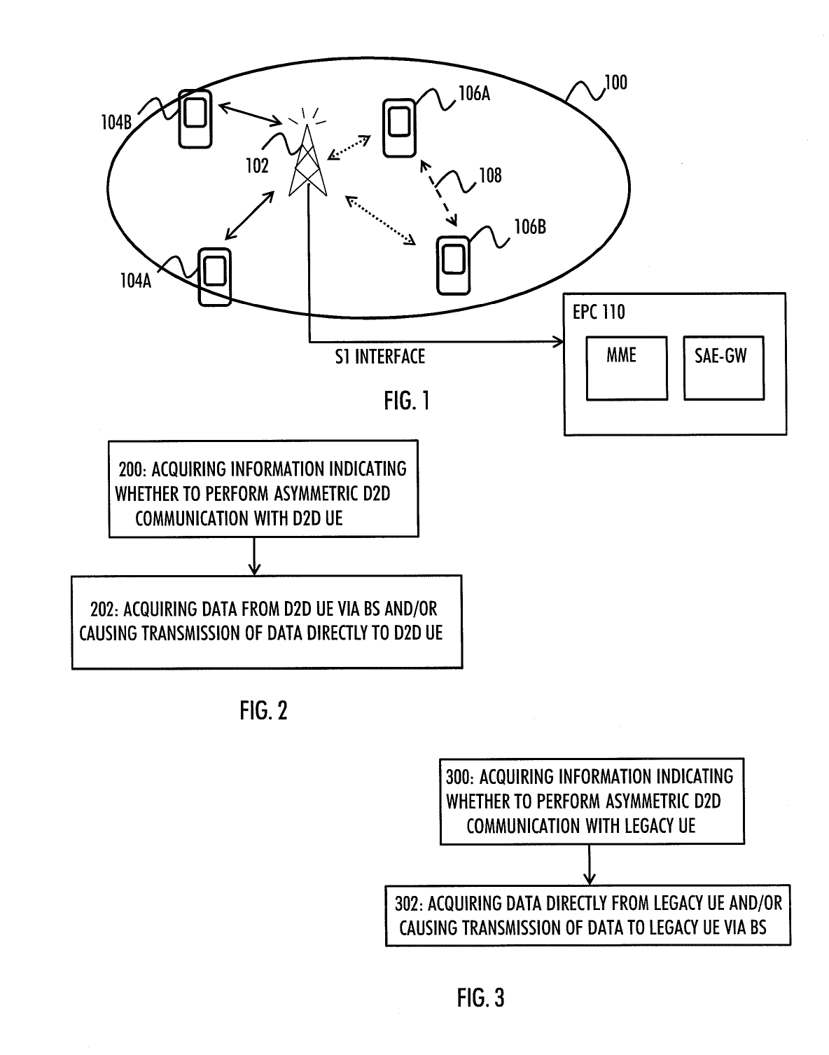

FIG. 1 shows a communication network where embodiments of the invention may be applicable. A base station 102 may be used in order to provide radio coverage to the cell 100. For the sake of simplicity of the description, let us assume that the base station is an eNB. In the case of multiple eNBs in the communication network, the eNBs may be connected to each other with an X2 interface, as specified in the LTE. The eNB 102 may be further connected via an S1 interface to an evolved packet core (EPC) 110, more specifically to a mobility management entity (MME) and to a system architecture evolution gateway (SAE-GW). The MME is a control plane for controlling functions of non-access stratum signaling, roaming, authentication, tracking area list management, etc., whereas the SAE-GW handles user plane functions including packet routing and forwarding, evolved-UMTS terrestrial radio access network (E-UTRAN) or LTE idle mode packet buffering, etc.

Still referring to FIG. 1, the eNB 102 may control a cellular radio communication links established between the eNB 102 and each of terminal devices 104A and 104B located within the cell 100. These communication links marked with solid arrows may be referred as conventional communication links or as cellular communication links for an end-to-end communication, where the source device transmits data to the destination device via the eNB 102. Therefore, the user terminals 104A and 104B may communicate with each other via the eNB 102. The terminal device may be a terminal device of a cellular communication system, e.g. a computer (PC), a sensor, a laptop, a palm computer, a mobile phone, or any other user terminal or user equipment capable of communicating with the cellular communication network.

In addition to or instead of conventional communication links, direct device-to-device (D2D), also known as mobile-to-mobile (M2M), terminal-to-terminal (T2T), peer-to-peer (P2P), connections may be established among terminal devices, such as terminal devices 106A and 106B. The D2D communication may be integrated into the cellular network, such as the LTE/LTE-A cellular network. The integration may denote that devices (or mobile or terminals or peers or machines) 106A and 106B having a direct physical communication link utilize the radio resources of the cellular network, thus sharing the cellular network resources with other devices 104A, 104B having the conventional cellular communication to the eNB.

Terminal devices that have established a radio resource control (RRC) connection with the eNB 102 may have their D2D communication links 108 controlled by the eNB 102 as shown with dotted arrows in FIG. 1. The control of a direct D2D communication link 108 may be carried out when an associated terminal device is either in an RRC idle state or in an RRC connected state. The radio access technology of the direct communication link 108 may operate on the same frequency band as the conventional communication link and/or outside those frequency bands to provide the arrangement with flexibility. Thus, the eNB 102 may be responsible for allocating radio resources to the direct communication link 108 as well as for the conventional communication links. The cellular network may be operating in a frequency division duplex (FDD) mode and the D2D connections 108 may utilize time division duplex (TDD) mode with the cellular network uplink (UL) resources controlled by the base station(s), such as the eNB 102. The D2D UT 106A may apply the UL resources in communication of data with the D2D UT 106B, and vice versa. The D2D UEs 106A, 106B may select the modulation and coding scheme (MCS) by themselves, without involvement by the eNB 102. The purpose of establishing a direct communication into the cellular network may be the possibility to reduce transmitter power consumption both in the user terminals (UTs) and in the eNB 102 (or any base station), increase the cellular network capacity and establishing more services for the users.

Before such direct D2D communication may take place, the user terminals may need to be aware of the presence of other user terminals capable of D2D communication. In order to enable this, a D2D discovery process may be applied. In the discovery process, the user terminal (UT) may, for example, inform other user terminals about the capability or desire to perform D2D communication directly with another UT. The other UTs may listen to such signalling and in this way also perform the D2D discovery process functions.

The existing D2D concepts and solutions require that UEs (or UTs) applying the D2D communication 108 are D2D capable, i.e. are D2D UEs. By D2D capable it may be meant that the UT 106A and 106B are equipped with an UL receiver for receiving data transmitted by using the UL resources. The existing DL receiver may not be tuned for receiving UL data, i.e. data transmitted on uplink resources, as then the tuned DL receiver may not listen to or receive any control signaling from the eNB simultaneously, which control signaling is transmitted on DL resources. That is, in case of tuning the existing DL receiver of a legacy UE for D2D communication on uplink resources, the legacy UE may miss the D2D commands or paging/data information from the eNB during the ongoing D2D communication. Therefore, a use of an additional UL receiver may be needed. As such, this may mean that the D2D UEs may only communicate with the other D2D UEs in D2D mode, which limits the D2D communication capabilities significantly. Let us denote such limited D2D communication as a symmetric D2D communication. In particular, the existing D2D symmetric concepts and solutions only provide D2D communication based on a bi-directional link, which only allows D2D communication within D2D capable devices comprising UL transmission (Tx) and reception (Rx) capable transceivers. Thus, any legacy UE without the UL receiver may not perform the symmetric D2D communication with D2D capable UEs. Thus, such symmetric D2D communication may worsen the end user experience since the D2D devices always have to find another D2D UE. This may restrict the D2D application especially during the ramping up of the D2D business. Furthermore, it may slow down or even kill D2D application deployment. For example, the D2D communication would be limited heavily due to the limited number of D2D UEs and applications.

Different compared to the symmetric communication mentioned above, it may be beneficial to provide solution for an asymmetric D2D communication mode in which the legacy UEs may communicate semi-directly with a D2D capable UEs with minor or even no modification. With respect to FIGS. 2 to 4, it is proposed in step 200 of FIG. 2 to acquire, by a first user terminal (UT or UE) 402 incapable to receive uplink data, information indicating whether or not to apply the asymmetric D2D communication with a second UE 404 capable to receive uplink data. Thus it may be that the first UE does not comprise the UL receiver, i.e. it may be a legacy UE or a sensor device capable of accessing the cellular radio interface, for example. However, the second UE 404 does comprise an UL receiver, i.e. the second UE 404 may be also called a D2D UE 404. The UL receiver may be tuned/designed/configured to receive UL data, i.e. data that is carried by the uplink resources of the cellular network. As the legacy UE does not comprise the UL receiver, it is clear that the symmetric D2D communication cannot take place between the first and the second UE 402 and 404. Looking from the point of view of the second UT 404 with respect to FIG. 3, the second UT 404 may in step 300 also acquire information indicating whether or not to apply the asymmetric D2D communication with the first UE 402. Details on how the acquiring of information takes place will be described later.

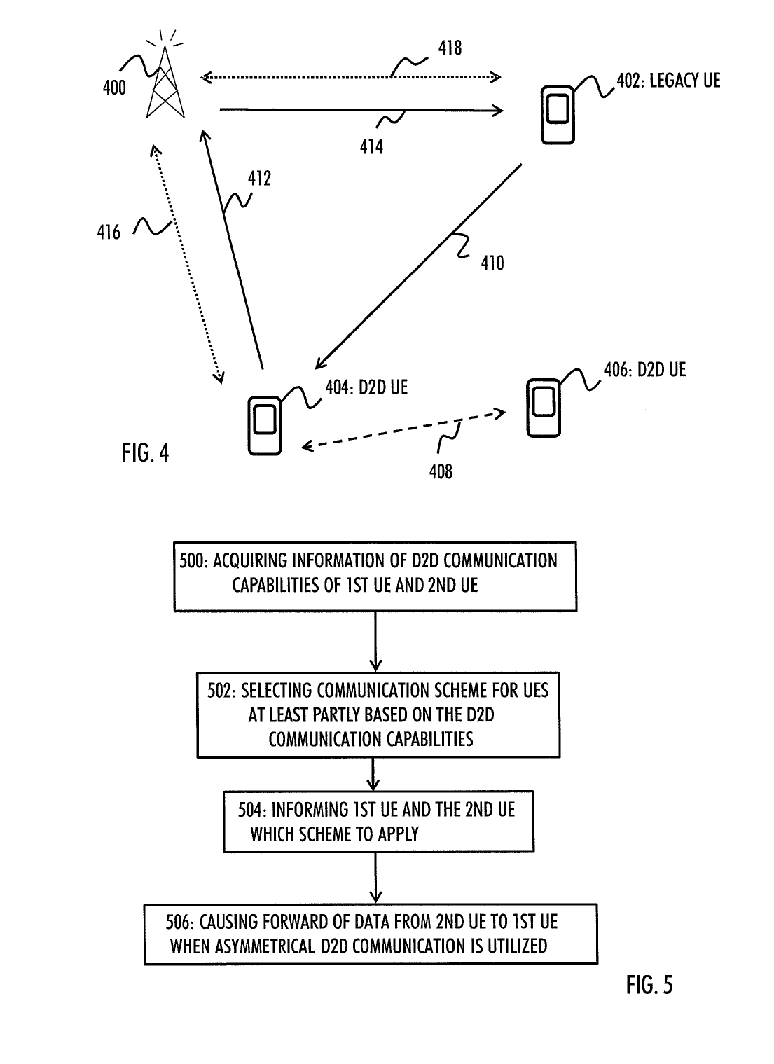

Thereafter, in steps 202 and 302, the asymmetric D2D communication between the legacy UE 402 and the D2D UE 404 may take place. The asymmetric D2D communication differs from the symmetric D2D communication in that only the first UE 402 may transmit UL data directly to the paired second UE 404. This may be because only the second UE 404 has the UL receiver. This is shown in FIG. 4, where the asymmetric D2D communication takes place according to solid arrows 410, 412 and 414. The arrow 410 from the first UE 402 to the second UE 404 depicts direct D2D transmission of information, such as user data or feedback, by applying the UL resources of the cellular communication network. In other words, the first UE 402 may reuse its UL transmitter in transmitting data directly to the second UE 404 and the second UE 404, being equipped with the UL receiver, may receive the data directly from the first UE 402 by using the UL receiver. However, the second UE 404, when applying the asymmetric D2D transmission instead of the symmetric one, may cause transmission of data to the first UE 402 via an eNB 400, or any base station of the cellular network. This is shown by arrows 412 and 414. The information, such as user data or feedback, transmitted according to arrow 412 may apply UL resources of the cellular network. The second UE 404 may transmit the data by using its UL receiver. In case of FDD mode, the UL resources may denote, for example, a different frequency band than the downlink (DL) resources. The eNB 400 may receive the information transmitted according to arrow 412. Consequently, the eNB 400, knowing that the data relates to the asymmetric D2D communication, may forward the received data to the first UE 402 according to arrow 414. This forward of data may apply the cellular DL resources, for example. Thereafter, the first UE 402 may acquire data from the second UE 404 via the eNB 400 of the cellular network. For the reception, the first UE 402 may apply its existing DL receiver. Thus, in the asymmetric D2D communication, even though the legacy UEs or sensor devices without any UL receiver may not be able to receive any messages directly from the D2D UEs, the legacy UEs may transmit messages directly to D2D UEs by reusing their existing UL transmitter.

The provision of the asymmetric D2D communication may pave a way for the evolution of the D2D communication due to backwards compatibility and, thus, compelling performance. The proposed solution may provide means for D2D communication that is compatible with the existing devices and may utilize the legacy UEs to ramp up the D2D communication by applying for example the discovery process. Therefore, a D2D product or a D2D service may be experimented with a low threshold by the end-users, which may enhance the D2D technology diffusion. As such, the asymmetric D2D communication may complement the symmetric D2D communication as a more integrated D2D concept.

In an embodiment, the cellular network is operating in the FDD duplex mode, wherein the D2D connections utilize the TDD duplex mode. Further, the cellular network UL resources may be controlled by the eNB 400. Thus, the eNB 400 may allow or specify the first and second UEs 402 and 404, respectively, to apply the UL resources. The D2D communication, including the asymmetrical D2D communication links 410-414 and a symmetrical D2D communication link 408 (shown in dashed arrow) taking place between two D2D UEs 404 and 406, may apply TDD duplex mode to ensure reliability. In FIG. 4, the dotted arrows 416 and 418 depict conventional cellular FDD communication taking place between the eNB 400 and the second UE 404 and between the eNB 400 and the first UE 402, respectively. The data communication on the connection links 416 and 418 may apply, for example, the FDD UL or the FDD DL resources of the cellular network, depending on is the eNB 400 receiving or transmitting data, respectively.

Let us now take a look at how the UEs 402 and 404 may receive the information indicating to apply the asymmetric D2D communication scheme. The eNB 400 may transmit an explicit signaling to the UEs 402 and 404 to apply the asymmetric D2D communication between the UEs 402 and 404. Alternatively, the signaling to apply the asymmetric D2D may be implicit. Therefore, the legacy UE 402 may operate in the conventional cellular mode through the connection link 418 or the legacy UE 402 may operate in the asymmetric D2D mode via links 410 to 414 based on explicit signaling or implicit signaling. When applying the explicit signaling, the legacy UE 402 or the D2D UE 404 may receive the mode operation command from the eNB 400, which mode operation command may be a new signaling from the eNB 400. The explicit mode operation command may indicate whether the receiving UE is to apply the asymmetric D2D communication with the other UE.

Let us assume, that the cellular device or sensor 402 transmits data to the D2D device 404 by applying the asymmetric D2D scheme and receives feedback from the D2D device 404 via the ENB 400 forwarding. As the feedback is received via the eNB 400, the hybrid automatic repeat request (HARQ) feedback delay may be different than in the symmetric D2D communication or in the conventional cellular mode. This may impact the HARQ buffer configuration, for example. Therefore, it may of importance to adapt the operational parameters of at least the first UE 402. Thus, upon receiving the explicit asymmetric D2D application command, the UE 402 may automatically reconfigure the operational parameters according to the predefined parameter settings associated with the operation mode, i.e. associated with the asymmetric D2D communication scheme, in order to enable the asymmetric D2D communication. The operational parameters may refer to HARQ process, such as to the HARQ buffer due to different ACK/NACK delay performance between the cellular mode and the asymmetric D2D mode.

Similarly, in an embodiment, the D2D device 404, upon acquiring an explicit signaling from the eNB 400 to apply the asymmetric D2D communication, may reconfigure its operational parameters according to predefined settings. For this, the UEs 402 and/or 404 may comprise a set of different parameter settings, each corresponding to a specific communication scheme, or an operational mode, wherein each communication scheme may utilize at least one of the following: a conventional communication between the UE and the eNB 400, the symmetric D2D communication, and the asymmetric D2D communication. Thus, the UE 402 or 404 when reconfiguring its operational parameters according to the indicated communication scheme may adapt to the requirements of, for example, the asymmetric D2D communication or any other indicated communication scheme. The explicit signaling may allow for low signaling overhead to the UEs as only an indication of the asymmetric mode needs to be sent, such as one bit of information indicating that the asymmetric mode is to be applied. It may be advantageous, for example, to the D2D UE as the D2D UE 404 may perform frequent mode switching between the symmetric D2D and the asymmetric D2D communication.

Regarding the implicit command to apply the asymmetric D2D communication, the first UE 402 or the second UE 404 may acquire a signaling from the base station to reconfigure the operational parameters according to indicated settings. The settings may refer, for example, to the HARQ process. The indicated settings may be those that are associated with the asymmetric D2D communication. The settings may be transmitted to the receiving UE through this signaling. In that case, the UE 402/404 may not need to comprise the settings in the memories beforehand. By acquiring the signaling, the UE 402 or 404 simultaneously obtains knowledge that the asymmetric D2D communication is to be applied with the other user terminal. Such implicit command may advantageously be backward compatible by reusing the existing parameter configuration signaling. For example, the legacy UE 402 may receive a conventional reconfiguration signaling from eNB 400 with a set of updated parameters adapting to the asymmetric D2D mode. From this, the legacy UE 402, for example, may derive that a change of operational mode from the conventional cellular communication to the asymmetric D2D communication is needed.

From the viewpoint of the eNB 400, the eNB 400 may cause transmission of indication to the first UE 402 and to the second UE 404, wherein the indication indicates to apply the communication scheme which utilizes the asymmetric D2D communication. As said, the indication may be explicit or implicit. In other words, as stated above, the indication may comprise at least one of the following: an explicit signaling to perform the asymmetric D2D communication, a signaling to reconfigure operational parameters according to predefined or indicated settings corresponding to the asymmetric D2D communication in order to enable the asymmetric D2D communication. In an embodiment, the eNB 400 may (re)configure itself for forwarding the messages from the D2D device 404 to the cellular device 402 when the asymmetric D2D communication is to be applied.

Still from the viewpoint of the eNB 400 with respect to FIG. 5, it is proposed that the eNB 400 acquires information of D2D communication capabilities of the first and the second UEs 402 and 404 in step 500. Thereafter, in step 502, the eNB 400 may select, at least partly based on the acquired D2D communication capabilities, which communication scheme is to be applied by the first and the second UEs 402 and 404 among a plurality of communication schemes. The selected communication scheme may utilize at least one of the following: a conventional cellular communication between the first and the second UEs 402, 404, a symmetrical D2D communication wherein each of the first and second UEs 402 or 404 transmits data directly to the other UE 404 or 402, an asymmetric D2D communication wherein only the first UE 402 transmits data directly to the second UE 404 by applying the uplink resources of the cellular network. How the selection is made will be described later. Consequently, the eNB 400 may in step 504 cause transmission of indication about which communication scheme to apply to the first UE 402 and to the second UE 404. As said, this may take place either explicitly or implicitly. In step 506, upon application of the communication scheme utilizing the asymmetric D2D communication, the eNB 400 may cause forwarding of data from the second UE 404 to the first user terminal 402. As said, this may be because the first UE 402 does not comprise an uplink receiver which could be used in receiving UL data, i.e. data carried on the uplink resources. Therefore, the data from the second UE 404 may need to be forwarded to the first UE 402 by the eNB 400 using DL resources, i.e. as DL data.

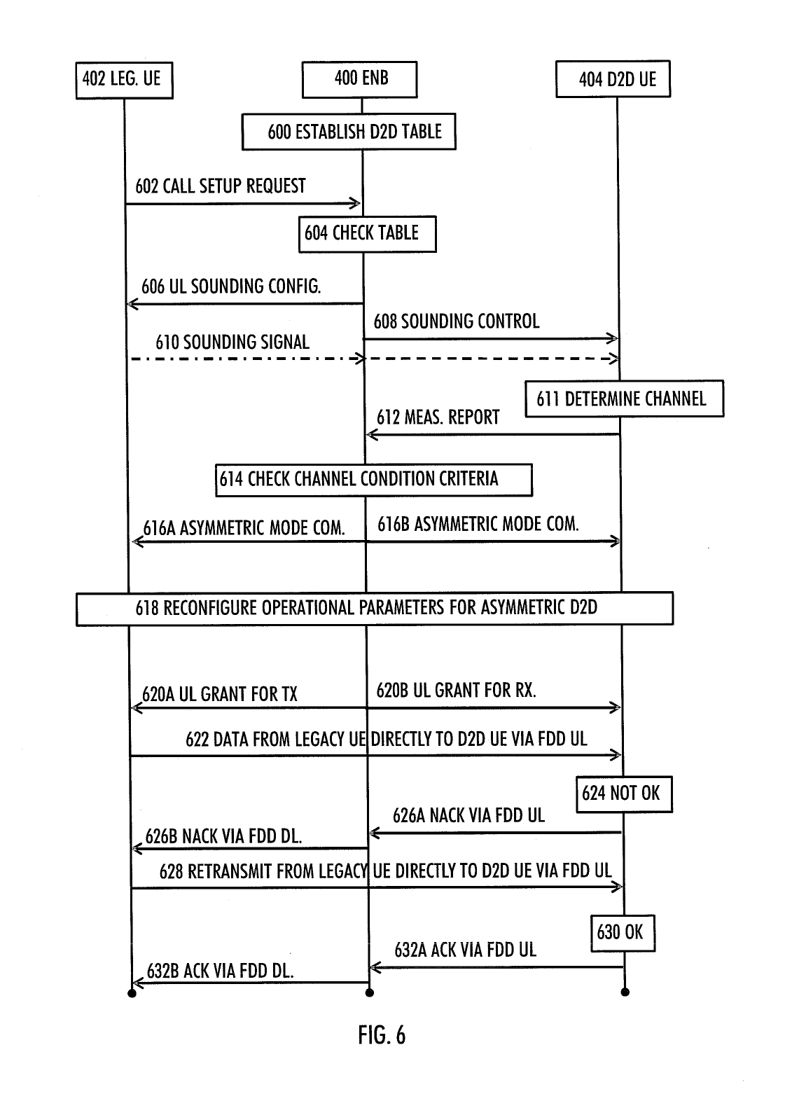

Let us now look in detail how the asymmetric D2D communication applying the resources of the cellular network is setup and applied. This is shown in FIG. 6 by means of a signaling flow diagram for setting up and applying the asymmetric D2D communication, according to an embodiment. Let us assume that the first UE 402 and the D2D UE 404 are in RRC_IDLE state. I.e. once the legacy 402 and/or D2D 404 devices has/have registered in the network, it/they are in the RRC_IDLE state and the eNB 400 may in step 600 establish a registration table with the UE capabilities and identity information to assist the setup process. The established table may comprise information on the D2D communication capabilities of the devices 402 and 404, which information may be obtained from the registration of the corresponding device 402 and 404.

Let us next assume that the first UE 402 tries to establish a call to the D2D device 404 locating in the same cell in step 602. The eNB 400 may then check the established table in step 604 and find whether or not it is possible to have an asymmetric D2D communication between the two devices 402, 404. In an embodiment, the eNB 400 may select the communication scheme (or operation mode) utilizing the asymmetric D2D communication when the first UE 402 is incapable to receive uplink data and the second UE 404 is capable to receive uplink data. This information may be found from the established table, for example. Therefore, it is not mandatory for the end user with the D2D device 404 to find a peer device with the D2D feature for the D2D application. As a result, any D2D device 404 may have a good user experience regardless of the peer device's capabilities. As an alternative, when both devices are cellular devices, i.e. incapable to receive UL data, the conventional cellular communication via the connection links 416 and 418 of FIG. 4 may be selected by the eNB 400.

However, in an embodiment, the selection of the communication scheme is based also on whether or not at least one predetermined channel condition criterion for the communication scheme is met. Thus, the eNB 400 may select the communication scheme utilizing the asymmetric D2D communication when the at least one predetermined channel condition criterion for utilizing the asymmetric D2D communication is met. The at least one predetermined channel condition criterion may indicate whether the D2D UE 404 is able receive data with a minimum signal to interference plus noise ratio (SINR) requirement and/or receive the data with a certain block error rate (BLER) requirement. Whether satisfying the criterion or not may depend, for example, on path loss between the corresponding entities and the transmission power of the transmitter. In case of symmetric D2D, both D2D UEs, such as UEs 404 and 406 of FIG. 4, need to fulfill the at least one channel condition related criterion, whereas in the asymmetric D2D only one UE 404, i.e. the D2D type of device 404, may need to fulfill the channel condition related criterion. This may be because the D2D UE 404 may be the only one receiving data directly from the first UE 402.

For example, when both devices are D2D devices (for example, when the UE 404 tries to call to the device 406 in FIG. 4), the eNB 400 may select the symmetric D2D communication when both devices 404 and 406 fulfill the channel condition related criterion. However, when only one device can fulfill the channel condition related criterion, due to different transmission powers, for example, the asymmetric D2D communication may be preferred and selected. Thus, the criterion for the asymmetric D2D mode with respect to the channel condition related criteria may be relaxed compared to the channel condition related criteria for the symmetric D2D communication mode. This may be advantageous in order to enable the D2D communication more often, thus increasing the efficiency of the cellular network. Thus, even though both UEs would be able to receive UL data, the eNB 400 may select to apply the asymmetric D2D scheme instead of the symmetric D2D communication. If it wasn't for the asymmetric D2D option, the eNB 400 might need to select the conventional cellular mode communication.

Coming back to FIG. 6, let us now take a look at how the eNB 400 acquires knowledge about whether or not the at least one predetermined criterion related to the channel conditions is met. After the call request from the device 402 is received and it is detected that the asymmetric D2D communication may be applied in terms of the D2D capabilities of the UEs 402 and 404, the eNB 400 may trigger an initial access procedure between the two devices 402 and 404 to check the connectivity. In step 606 the eNB 400 may cause transmission of information to the first UE 402, wherein the information indicates the first user terminal 402 to transmit a sounding signal. The information may indicate to transmit separate sounding signals for the eNB 400 and for the second UE 404, for example. Alternatively, the information may indicate to broadcast or multicast a single sounding signal so that the eNB 400 and the second UE 404 both may receive it. In an embodiment, the first UE 402 may transmit a probing signal by reusing a UL sounding signal, as in the cellular mode. Further, the eNB 400 may in step 608 cause transmission of information to the second UE 404, wherein the information indicates the second UE 404 to receive or to listen to the sounding signal from the first UE 402. Such control of the UEs 402/404 operation may take place via a layer 3 signaling, for example. In other words, the eNB 400 may configure the UL sounding transmission for the legacy device 402. Accordingly, eNB 400 may also ask the D2D device 404 to perform measurement according to the measurement control message 608.

The first UE 402 may cause transmission of the sounding signal in step 610 in order for the eNB 400 to determine whether the at least one predetermined channel condition criterion for the asymmetric D2D communication is met or not. The second UE 404, after acquiring information from the eNB 400 to receive the sounding signal from the first UE 402, may acquire the sounding signal. Thereafter, the UE 404 may determine the channel condition between the first UE 402 and the second UE 404 in step 611 based on the acquired sounding signal. After determining the channel condition, the UE 404 may cause transmission of information indicating the channel condition to the eNB 400 in step 612 in order for the eNB 400 to determine whether or not the at least one predetermined channel condition criterion for the asymmetric D2D communication is met. Although, the UE 404 may in step 611 determine the channel condition, the UE 404 may alternatively leave the channel condition determination for the eNB 400 by transmitting only the measurement report, not the derived channel condition, to the eNB 400 in step 612.

Consequently, the eNB 400 may acquire the sounding signal from the first UE 402 and determine the channel condition to/from the first UE 402 based on the acquired sounding signal. The eNB 404 may also acquire information from the second UE 404 indicating the channel condition between the first UE 402 and the second UE 404 in step 612. After the eNB 400 has obtained such knowledge, the eNB 400 may determine whether or not the at least one predetermined channel condition criterion for utilizing the asymmetric D2D communication is met based on the determined and the acquired channel conditions. Such determination may take place in step 614. When the asymmetric communication criteria with respect to the channel conditions are fulfilled according to the measurement report from D2D device 404 and the eNB measurement, the eNB 400 may confirm that the connectivity is ok to perform the asymmetric D2D communication between the UEs 402 and 404. When the determination in step 614 indicates that none of the channel condition criteria is fulfilled, the eNB 400 may decide to apply the conventional cellular mode instead or to cancel the call.

Next, the eNB 400 may send the D2D asymmetric mode command (an explicit or an implicit command) to the legacy device 402 and to the D2D device 404 in steps 616A and 616B, respectively, to imply that the legacy UE 402 may communicate to the D2D device 404 in the asymmetric D2D communication mode. Accordingly, in step 618, the devices 402 and 404 and the eNB 400 may (re)configure their protocol entities and operational parameters with the predefined or indicated parameter settings in order to enable the asymmetric D2D communication. Such configuration of operational parameters may comprise the adjustment of HARQ buffer, for example.

Although not shown in FIG. 6, the eNB 400 may also assist the UEs 402 and 404 in completing the D2D communication setup, e.g. by allocating a common radio network temporary identification (RNTI) for the pair of devices 402 and 404, or informing the devices 402 and 404 the peer's RNTI. As a result, the asymmetric D2D communication setup phase may be completed and the user data transfer may take place according to the asymmetric D2D communication.

In step 620A during transmission, the eNB 400 may grant UL transmission (Tx) resources to the legacy UE 402 using the RNTI for the pair or the RNTI of the UE 402. The D2D device 404 may also decode the UL Tx grant in step 620B and reinterpret the UL Tx grant as information about how to receive the packets from the legacy UE 402, i.e. re-interpret the information as UL grant for reception (Rx). Thereafter, in step 622, the UE 402 may transmit data directly to the D2D UE 404 on UL resources. Let us assume that the second UE 404 is not able to decode the data properly in step 624. As a consequence, the UE 404 may transmit a NACK feedback message to the legacy UE 402 via the eNB 400 forwarding, as shown in steps 626A and 626B. These transmissions may apply UL resources (signal 626A) and DL resources (signal 626B). Then the legacy UE 402 may re-transmit the data in step 628. This time the user data may be properly received by the D2D UE 404 in step 630 and consequently an ACK feedback message to the legacy UE 402 via the eNB 400 forwarding may take place in steps 632A and 632B. After this, a new transmission may take place. The data communication in the asymmetric D2D scheme may take place by applying the TDD duplex mode. In order to maintain the synchronous HARQ for the legacy UE 402, the eNB 400 forwarding is designed not lead to big variations with respect to delay, as any big delay may impact the HARQ buffer configuration for the legacy UE 402.

In an embodiment, the first UE 402 may cause forwarding of data from the eNB 400 to at least one second UE 404, wherein the data is received in downlink resources and forwarded in uplink resources. Thus, the legacy UE 402 may be seen in this embodiment as a downlink relay to forward the eNB messages to D2D UEs 404. For example, the legacy UE 402 may receive the messages from the eNB 400 in the DL band and transmit the messages to D2D UEs 404 in the UL band.

In an embodiment, the first UE 402 may cause broadcast of data to multiple second user terminals 404, i.e. to a group of second UE 404. Further, if no feedback is required for this kind of broadcasting service, the implementation may be further simplified for the legacy UEs 402, as no HARQ buffer reconfiguration is needed, for example. As a comparison, it may be said that broadcasting via the symmetric D2D communication may require setting up a bidirectional communication links between the UEs. This may be lead to inefficient use of resources as the broadcasting service may not need any bidirectional link. The broadcast carried out during the asymmetric D2D communication may allow for a distributed D2D broadcasting where multiple legacy UEs 402 (or sensors) may broadcast the same information locally to multiple D2D devices 404.

In an embodiment, the eNB 400 may control the transmission power of the first UE 402 to correspond to the direct communication link to the second UE 404. This may be done even during the asymmetric D2D communication by power control commands from the eNB 400 in order to save the power and reduce the interference.

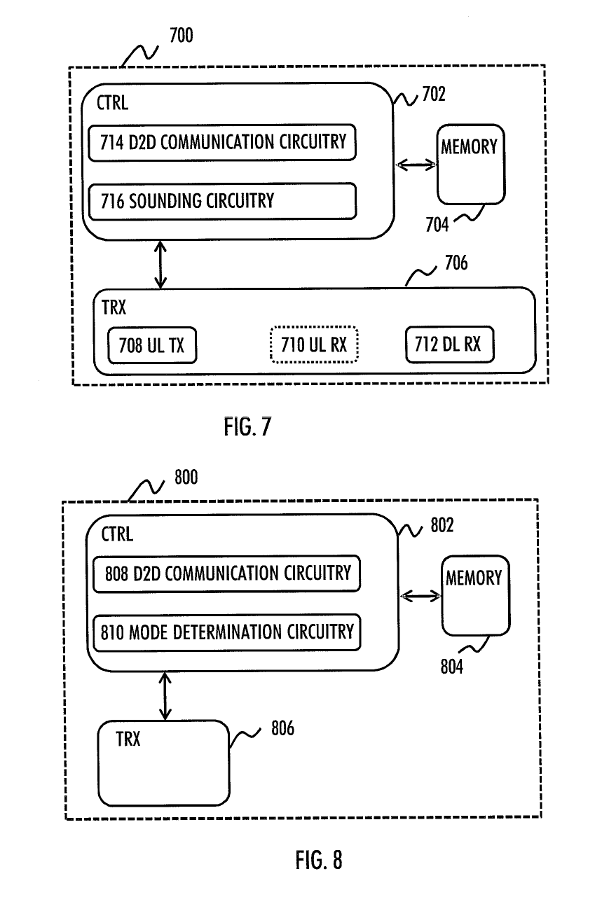

An embodiment, as shown in FIGS. 7 and 8, provides apparatuses 700 and 800, each comprising at least one processor 702, 802 and at least one memory 704, 804 including a computer program code, wherein the at least one memory 704, 804 and the computer program code are configured, with the at least one processor 702, 802, to cause the apparatus 700, 800 to carry out any one of the above-described processes. It should be noted that FIGS. 7 and 8 show only the elements and functional entities required for understanding the apparatus 700 and 800. It is apparent to a person skilled in the art that the apparatus may also comprise other functions and structures. The at least one processor 702, 802 may be implemented with a separate digital signal processor provided with suitable software embedded on a computer readable medium, or with a separate logic circuit, such as an application specific integrated circuit (ASIC). The at least one processor 702, 802 may comprise an interface, such as computer port, for providing communication capabilities

The apparatus 700 may comprise the terminal device of a cellular communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities. Further, the apparatus 700 may be or comprise a module (to be attached to the UE) providing connectivity, such as a plug-in unit, an “USB dongle”, or any other kind of unit. The unit may be installed either inside the UE or attached to the UE with a connector or even wirelessly.

In an embodiment, the apparatus 700 may be seen as the legacy UE 402. In this case, the UL receiver 710 may be omitted from the apparatus. In another embodiment, the apparatus 700 may be seen as the D2D UE 404. In this case, the UL receiver 710 may be present in the apparatus in order to receive UL data from the legacy UE 402 according to the asymmetric D2D communication.

As shown, the apparatus 700 may further comprise radio interface components (TRX) 706 providing the apparatus with radio communication capabilities with the radio access network. The radio interface components 706 may comprise an UL transmitter 708 for transmitting data on UL resources, a downlink receiver 712 for receiving data on DL resources, and, when the apparatus is the D2D UE 404, an UL receiver for receiving data on UL resources. Further, the TRX 706 may comprise standard well-known components such as amplifier, filter, frequency-converter, (de)modulator, and encoder/decoder circuitries and one or more antennas. The memory 704 may be used to store data related to the operational parameters of the communication scheme, HARQ buffer, channel condition related data, sounding signal configuration, etc.

The at least one processor 702 may comprise a D2D communication circuitry 714. The circuitry 714 may perform functions according to the symmetric D2D communication scheme (only when seen as the D2D UE 404) or according to the asymmetric D2D communication scheme. Thus, it may acquire information on which scheme is to be applied and adjust the operational parameters of the apparatus 700 accordingly, for example. The at least one processor 702 may also comprise a sounding circuitry 716 for performing the transmission of a probing (sounding) signal or for performing the measurement of the sounding signal and optionally the channel condition determination based on the received sounding signal, depending on is the apparatus 700 seen as the legacy UE 402 or as the D2D UE 404.

The apparatus 800 may be comprised in a base station (also called a base transceiver station, a Node B, a radio network controller, or an evolved Node B, for example). The apparatus 800 may comprise a circuitry, e.g. a chip, a processor, a micro controller, or a combination of such circuitries in the base station and cause the base station to carry out the above-described functionalities. The apparatus 800 may comprise transceiver 806 providing the apparatus with radio communication capabilities with the radio access network. The TRX 806 may forward the data to the legacy UE 402 during the asymmetric D2D communication, for example. The memory 804 may store information about the at least one criterion related to the channel condition for each communication scheme, operation parameters for each communication scheme, etc.

The at least one processor 802 may comprise a D2D communication circuitry 808 for performing functionalities of the D2D communication, such as controlling the use of UL resources, performing the power control, causing forward of data during the asymmetric D2D communication scheme, etc. The at least one processor 802 may also comprise a mode (i.e. communication scheme) determination circuitry 810 for determining which communication scheme to apply among the plurality of communication schemes. For this the circuitry 810 may use the knowledge of the D2D capabilities of the UEs and the channel conditions between the UEs 402 and 404 and between the legacy UE 402 and the apparatus 800, for example.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configured to carry out any of the embodiments of FIGS. 1 to 8. In an embodiment, the at least one processor 702, the memory 704 and a computer program code form an embodiment of processing means for carrying out the embodiments of the invention. In another embodiment, the at least one processor 802, the memory 804 and a computer program code form an embodiment of processing means for carrying out the embodiments of the invention.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
acquiring, by a first user terminal incapable to receive uplink data, information indicating whether or not to apply an asymmetric device-to-device, D2D, communication with a second user terminal capable to receive uplink data; and
upon applying the asymmetric D2D communication with the second user terminal, performing at least one of the following: acquiring data from the second user terminal via a base station of the cellular network, and causing transmission of data directly to the second user terminal.

2. The method of claim 1, further comprising:
acquiring an explicit signaling from the base station to apply the asymmetric D2D communication; and
upon acquiring the explicit signaling, reconfiguring operational parameters according to predefined settings in order to enable the asymmetric D2D communication.

3. The method of claim 1, further comprising:
acquiring a signaling from the base station to reconfigure operational parameters according to indicated settings in order to enable the asymmetric D2D communication; and
upon acquiring the signaling, obtaining knowledge that the asymmetric D2D communication is to be applied with the second user terminal.

4. The method of claim 1, further comprising:
acquiring information to transmit a sounding signal; and
causing transmission of the sounding signal in order to enable the base station to determine whether or not at least one predetermined channel condition criterion for the asymmetric D2D communication is met.

5. The method of claim 1, further comprising:
causing forwarding of data from the base station to at least one second user terminal, wherein the data is received in downlink resources and forwarded in uplink resources.

6. The method of claim 1, further comprising:
causing broadcast of data to multiple second user terminals.

7. An apparatus, comprising:
at least one processor and at least one memory including a computer program code, wherein the at least one memory and the computer program code are configured to, with the at least one processor, cause the apparatus at least to:
acquire information indicating whether or not a first user terminal incapable to receive uplink data is to apply an asymmetric device-to-device, D2D, communication with a second user terminal capable to receive uplink data; and
upon applying the asymmetric D2D communication with the second user terminal, perform at least one of the following: acquire data from the second user terminal via a base station of the cellular network, and cause transmission of data directly to the second user terminal.

8. The apparatus of claim 7, wherein the apparatus is further caused to:
acquire an explicit signaling from the base station to apply the asymmetric D2D communication; and
upon acquiring the explicit signaling, reconfigure operational parameters according to predefined settings in order to enable the asymmetric D2D communication.

9. The apparatus of claim 7, wherein the apparatus is further caused to:
acquire a signaling from the base station to reconfigure operational parameters according to indicated settings in order to enable the asymmetric D2D communication; and
upon acquiring the signaling, obtain knowledge that the asymmetric D2D communication is to be applied with the second user terminal.

10. The apparatus of claim 7, wherein the apparatus is further caused to:
acquire information to transmit a sounding signal; and
cause transmission of the sounding signal in order to enable the base station to determine whether or not at least one predetermined channel condition criterion for the asymmetric D2D communication is met.

11. The apparatus of claim 7, wherein the apparatus is further caused to:
cause forwarding of data from the base station to at least one second user terminal, wherein the data is received in downlink resources and forwarded in uplink resources.

12. The apparatus of claim 7, wherein the apparatus is further caused to:
cause broadcast of data to multiple second user terminals.

13. An apparatus, comprising:
at least one processor and at least one memory including a computer program code, wherein the at least one memory and the computer program code are configured to, with the at least one processor, cause the apparatus at least to:
acquire information of device-to-device, D2D, communication capabilities of a first user terminal and a second user terminal;
select, at least partly based on the acquired D2D communication capabilities, which communication scheme is to be applied by the first user terminal and the second user terminal among a plurality of communication schemes, wherein the selected communication scheme utilizes at least one of the following: a conventional cellular communication between the first and second user terminals, a symmetrical D2D communication wherein each of the first and second user terminal transmits data directly to the other user terminal, an asymmetric D2D communication wherein only the first user terminal transmits data directly to the second user terminal by applying the uplink resources of the cellular network;
cause transmission of indication about which communication scheme to apply to the first user terminal and the second user terminal; and
upon application of the communication scheme utilizing the asymmetric D2D communication, cause forwarding of data from the second user terminal to the first user terminal.

14. The apparatus of claim 13, wherein the apparatus is further caused to:
select the communication scheme utilizing asymmetric D2D communication when the first user terminal is incapable to receive uplink data and the second user terminal is capable to receive uplink data.

15. The apparatus of claim 13, wherein the selection of the communication scheme is based also on whether or not at least one predetermined channel condition criterion for the communication scheme is met, and the apparatus is further caused to:
select the communication scheme utilizing asymmetric D2D communication when the at least one predetermined channel condition criterion for utilizing the asymmetric D2D communication is met and the first user terminal is incapable to receive uplink data and the second user terminal is capable to receive uplink data.

16. The apparatus of claim 15, wherein the apparatus is further caused to:
cause transmission of information to the first user terminal, wherein the information indicates the first user terminal to transmit a sounding signal;
cause transmission of information to the second user terminal, wherein the information indicates the second user terminal to receive the sounding signal from the first user terminal;
acquire the sounding signal from the first user terminal and determining channel condition to/from the first user terminal based on the acquired sounding signal; and
acquire information from the second user terminal indicating the channel condition between the first user terminal and the second user terminal based on the transmitted sounding signal; and
determine whether or not the at least one predetermined channel condition criterion for utilizing the asymmetric D2D communication is met based on the determined and the acquired channel conditions.

17. The apparatus of claim 13, wherein the selection of the communication scheme is based also on whether or not at least one predetermined channel condition criterion for the communication scheme is met, and the apparatus is further caused to:
select the communication scheme utilizing the asymmetric D2D communication when only one of the two user terminals is able to meet the at least one predetermined channel condition criterion for the symmetric D2D communication, wherein both of the first user terminal and the second user terminal are capable to receive uplink data.

18. The apparatus of claim 13, wherein the apparatus is further caused to:
cause transmission of indication to the first user terminal and to the second user terminal, wherein the indication indicates to apply the communication scheme which utilizes the asymmetric D2D communication and the indication comprises at least one of the following: an explicit signaling to perform the asymmetric D2D communication, a signaling to reconfigure operational parameters according to predefined or indicated settings corresponding to the asymmetric D2D communication.

19. The apparatus of claim 13, wherein the apparatus is further caused to:
control transmission power of the first user terminal to correspond to the direct communication link to the second user terminal.
